(19) United States
(12) Patent Application Publication
(10) Pub. No.: US 2005/0100794 A1
(43) Pub. Date: May 12, 2005

(54) Separator for electrochemical devices and methods

(75) Inventors: Richard V. Chamberlain II, Boston, MA (US); Per T. Onnerud, Framingham, MA (US); Jay Jie Shi, Acton, MA (US); Jack Treger, Quincy, MA (US)

Correspondence Address: LOWRIE, LANDO & ANASTASI, RIVERFRONT OFFICE, ONE MAIN STREET, ELEVENTH FLOOR, CAMBRIDGE, MA, 02142, US

(73) Assignee: TIAX, LLC, Cambridge, MA (US)

(21) Appl. No.: 10/702,918

(22) Filed: Nov. 6, 2003

(51) Int. Cl. H01M 2/16; H01M 2/14

(52) U.S. Cl. 429/247; 429/249; 429/253; 429/129

(57) ABSTRACT

A separator for an electrochemical device comprises a porous, ion-permeable material coated, on a surface thereof, a thermally sensitive layer comprising a polymeric material secured with a cross-linked adhesive and an adhesion promoter. The separator can be prepared by disposing, on a surface thereof, a thermally sensitive layer comprising heat-fusible material, a cross-linkable adhesive and an adhesion promoter, all of which dispersed in a solvent having a polar component, a non-polar component and a high boiling point component.

### BACKGROUND OF THE INVENTION

1. Field of the Invention

The present invention relates to a separator in an electrochemical device and methods of coating the separator and, in particular, to separators having a thermally sensitive coating disposed on a surface of a porous polymeric material and methods of coating.

2. Description of Related Art

An electrochemical cell can comprise a separator that electrically separates or isolates an anode from a cathode. Separators can comprise a porous material that permits ionic transport therethrough between the anode and the cathode. The separator can further comprise a thermally sensitive or heat-sensitive material that can become heat-fusible within the porous structure of the porous separator and render the separator, at least partially, ionically impermeable.

For example, Faust et al., in U.S. Pat. No. 4,471,979, disclose a battery separator assembly comprising a film bearing a thermal fuse in the form of a layer of wax-coated fibers.

Lundquist et al., in U.S. Pat. Nos. 4,650,730 and 4,731,304, disclose a battery separator comprised of a multi-ply sheet product with at least one ply capable of transforming to a substantially non-porous membrane at a temperature between 80° C. and 150° C. and at least one ply capable of maintaining porosity at ambient temperature to at least 10° C. greater than the transformation temperature of the first ply.

Taskier et al., in U.S. Pat. No. 4,973,532, disclose a battery separator with an integral thermal fuse. The battery separator has a porous substrate and a thermal fuse material adhered to at least one surface of the porous substrate in a predetermined geometric array pattern that establishes open areas of the porous substrate that allow ionic migration therethrough. The thermal fuse material melts at or near a predetermined threshold temperature that irreversibly decreases the substrate's permeability.

Treger, in U.S. Pat. No. 5,091,272, discloses a heat-sensitive film for use as a separator in an electrochemical cell. The heat-sensitive film becomes substantially impermeable to air or ion flow above a predetermined temperature. The film comprises a microporous layer coated with a layer of heat-fusible polymer particles.

Gee et al., in U.S. Pat. No. 5,543,365, disclose a battery with a fusible electrolyte. The fusible electrolyte contains dispersed fusible particles.

Further, Ullrich et al., in U.S. Pat. No. 6,511,517, disclose a method for producing a secondary lithium cell comprising a heat-sensitive protective mechanism. The method is carried out to coat the electrodes and/or the separator by means of electrostatic powder coating with wax particles.

In addition, Fritts, in U.S. Pat. No. 4,075,400 disclose an over-temperature battery deactivation system wherein a battery-poisoning agent is contained in a thermoplastic encapsulating material. The encapsulating material will melt at a predetermined temperature and release the poisoning agent that deactivates the portion of the battery exceeding the predetermined temperature.

### BRIEF SUMMARY OF THE INVENTION

The present invention is directed to a separator typically comprising a porous, ion-permeable film coated with a thermally sensitive layer. The separator can be utilized in electrochemical devices such as primary and/or secondary batteries. The present invention is also directed to techniques of preparation, including coating, an ion-permeable material suitable for use as a separator in electrochemical devices.

In accordance with one or more embodiments, the present invention provides a thermally sensitive or heat-sensitive coating solution for a battery separator. The thermally sensitive coating can comprise a plurality of heat-fusible particles, an adhesive comprising a cross-linkable polymer, an olefinic adhesion promoter comprising a polar modified polyolefin, and a solvent.

In accordance with one or more embodiments, the present invention provides a batter separator. The battery separator can comprise a porous polymeric film with a melting point of at least about 130° C. coated with a thermally sensitive coating disposed on a surface of the porous polymeric film and a binder comprising a cross-linked adhesive and an adhesion promoter. The thermally sensitive coating comprising heat-fusible polymeric particles having a melting point of less than the melting point of the porous polymeric film.

In accordance with one or more embodiments, the present invention provides an electrochemical cell. The electrochemical cell comprises a separator disposed to electrically separate an anode and a cathode. The separator comprises a porous polymeric material and a thermally sensitive coating disposed on a surface of the separator, the thermally sensitive coating comprising heat-fusible polymeric particles, an adhesion promoter comprising a polyolefin having at least one pendant hydroxyl, carboxylic and chlorinated functional group, and a cross-linked adhesive.

In accordance with one or more embodiments, the present invention provides a method of preparing a separator coating solution. The method can comprise dissolving a cross-linkable adhesive in a solvent solution comprising a polar component, a non-polar component, and a high boiling point component selected from the group consisting of diethyleneglycol dibutylether and a mixture of aromatics, ketones, and esters and dispersing heat-fusible material in the solvent solution.

In accordance with one or more embodiments, the present invention provides a method of preparing a thermally sensitive separator. The method can comprise providing a coating solution comprising a heat-fusible material, an adhesive and an adhesion promoter in a solvent solution comprising a polar component, a non-polar component and a high boiling point component selected from the group consisting of diethyleneglycol dibutylether and a mixture of aromatics, ketones, and esters; applying the coating solution on a surface of a porous material; and vaporizing at least a portion of the solvent from the coating solution to coat the surface of the porous material with a thermally sensitive layer comprising the heat-fusible material.

In accordance with one or more embodiments, the present invention provides a method of coating a separator. The method can comprise preparing a coating solution consisting essentially of a plurality of heat-fusible materials, an adhesive, an adhesion promoter and a solvent mixture, applying the coating solution on a surface of the separator, and vaporizing at least a portion of the solvent from the coating solution to coat the surface of the separator with a thermally sensitive layer comprising a heat-fusible material.

Other advantages, novel features, and objects of the invention will become apparent from the following detailed description of non-limiting embodiments of the invention when considered in conjunction with the accompanying drawings, which are schematic and which are not intended to be drawn to scale. In the figures, each identical or nearly identical component that is illustrated in various figures typically is represented by a single numeral. For purposes of clarity, not every component is labeled in every figure, nor is every component of each embodiment of the invention shown where illustration is not necessary to allow those of ordinary skill in the art to understand the invention. In cases where the present specification and a document incorporated by reference include conflicting disclosure, the present specification shall control.

### BRIEF DESCRIPTION OF THE DRAWINGS

Preferred non-limiting embodiments of the present invention will be described by way of examples with reference to the accompanying drawings, in which:

FIG. 1 is a schematic diagram showing a cross-section of a portion of a separator in accordance with one or more embodiments of the present invention;

FIG. 2 is a schematic diagram showing a cross-section of an electrochemical cell in accordance with one or more embodiments of the present invention; and

FIG. 3 is a schematic drawing showing a partially transformed separator having reduced ion permeability in accordance with one or more embodiments of the present invention.

### DETAILED DESCRIPTION OF THE INVENTION

Lithium ion based secondary electrochemical devices can have high energy density. However if the energy were uncontrollably released, the sudden increase in electrical and ionic current can effect an undesirable increase in temperature that may result in runaway, uncontrolled thermochemical reactions. In some cases, such conditions can further lead to self-ignition and significant injury to property or person. Thermochemical reactions can occur between the anode and electrolyte and/or the cathode and electrolyte, which can raise temperatures at least about 120° C. and 150° C., respectively. If sufficient heat is generated, a separator can degrade and allow undesirable electrical communication between the anode and the cathode.

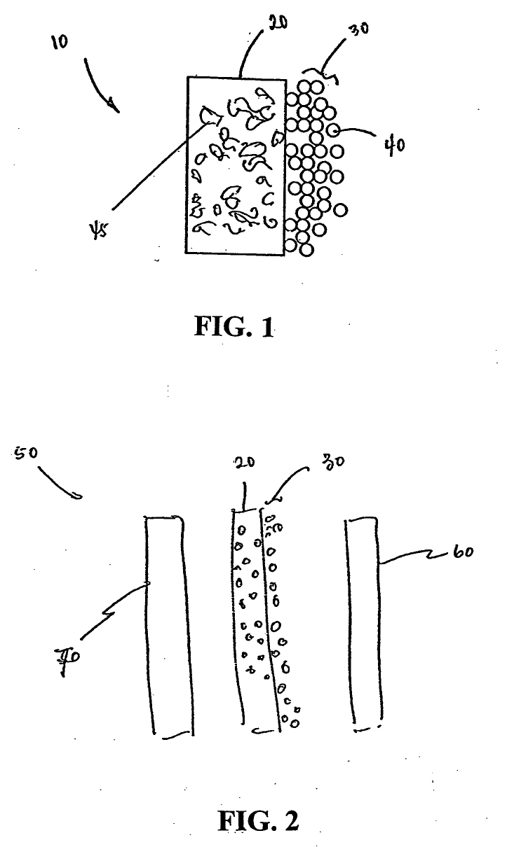

As shown in the exemplary embodiment depicted in FIG. 1, the articles and techniques of the present invention can provide a separator 10 that typically comprises a porous, ion-permeable material 20, typically formed and/or utilized as a film, coated with a thermally sensitive coating or layer 30. Thermally sensitive layer 30 typically comprises heat-fusible materials 40, which can be polymeric particles having various shapes and dimensions and have a melting temperature less than a melting temperature of porous material 20. Heat-fusible material 40 is typically secured by an adhesive, preferably a cross-linked adhesive with an adhesion promoter, together and to porous material 20. Preferably, thermally sensitive layer 30 can render at least a portion of porous material 20 ionically impermeable when heat-fusible material 40 reaches its melting point and becomes sufficiently fluid to fill or at least partially cover pores 45 and/or reduce the effective porosity of porous material 20. The separator of the present invention can be utilized in electrochemical devices such as primary and/or secondary batteries and provide an effective technique for controlling uncontrolled or undesirable reactions in such electrochemical devices. In accordance with further embodiments of the present invention, the thermally sensitive layer can consist essentially of a plurality of heat-fusible material or particles secured by an adhesion promoter.

The present invention is also directed to techniques of preparation, including coating, an ion-permeable material suitable for use as a separator in electrochemical devices.

In accordance with one or more embodiments, the present invention provides an electrochemical cell 50 as exemplarily shown in FIG. 2. Electrochemical cell 50 typically comprises a thermally sensitive separator 10 disposed to electrically separate an anode 60 and a cathode 70. Separator 10 can comprise a porous polymeric material 20 and a thermally sensitive coating 30 disposed on a surface of the separator. Thermally sensitive coating 30 typically comprises heat-fusible polymeric particles 40, an adhesion promoter comprising a polyolefin, preferably a polar modified polyolefin, having at least one pendant hydroxyl, carboxylic and chlorinated functional group, and a cross-linked adhesive. In accordance with one or more embodiments, the melting point of the heat-fusible polymeric particles is typically less than a melting point of the porous polymeric material.

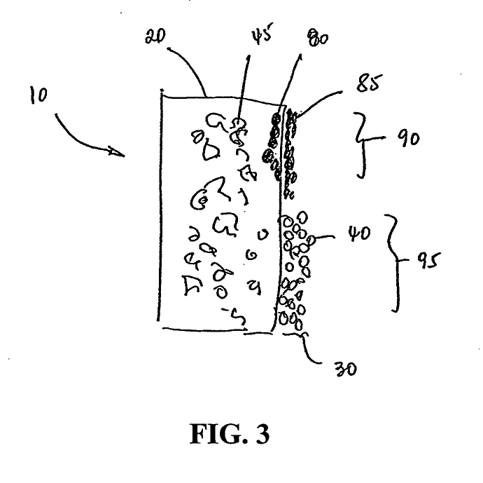

In accordance with one or more embodiments, the present invention provides a thermally sensitive separator coated with a heat-sensitive coating comprising heat-fusible material that, upon melting, can render the coated separator, at least partially, ionically impermeable. As schematically shown in FIG. 3, if the temperature of the separator and/or the heat-fusible material becomes sufficiently high to melt the heat-fusible material 40 in layer 30, pores 45 and be filled 80, at least partially, and/or coated 85 by the molten heat-fusible material. In some cases, a first region 90 of the separator can be rendered ionically impermeable while a second region 95 can remain ionically permeable as a consequence of having pores filled and/or encased by the heat-fusible material.

In accordance with one or more embodiments, the present invention can provide a separator coating solution that can be applied on a separator substrate to render the separator thermally sensitive. The separator coating solution of the present invention can comprise an adhesion promoter with an adhesive that bonds the heat-fusible material to the substrate or separator as well as to itself. It may be desirable to manufacture a thermally sensitive separator without allowing the thermally sensitive coating to be scraped or otherwise be removed from the substrate in order to maximize the degree of thermal shutdown of the separator during an abusive event. Therefore, it may be desirable to increase the adhesion of the thermally sensitive material sufficient to prevent the thermally sensitive coating from scraping, peeling, shearing or otherwise falling off the substrate, without adversely affecting cell performance or thermal shutdown response.

In accordance with one or more embodiments, the present invention provides a thermally sensitive coating solution for a battery separator. The thermally sensitive or heat-sensitive coating solution can comprise a plurality of heat-fusible materials, such as wax particles, having a melting point of about 85° C. to about 120° C., an adhesive comprising a cross-linkable polymer, an adhesion promoter comprising a polar modified polyolefin, and a solvent. In accordance with some embodiments of the present invention, the thermally sensitive or heat-sensitive coating solution can consist, or consist essentially, of a plurality of heat-fusible materials, such as wax particles, having a melting point of about 85° C. to about 120° C., an adhesive comprising a cross-linkable polymer, an adhesion promoter comprising a polar modified polyolefin, and a solvent. In accordance with other embodiments of the present invention, the thermally sensitive or heat-sensitive coating solution can consist, or consist essentially, of a plurality of heat-fusible materials, such as wax particles, having a melting point of about 85° C. to about 120° C., an adhesive comprising a cross-linkable polymer, an adhesion promoter comprising a polar modified polyolefin, and a solvent.

In accordance with one or more embodiments, the present invention provides a battery separator. The battery separator can comprise a porous polymeric film or substrate coated with a thermally sensitive coating disposed on a surface of the porous polymeric film. The thermally sensitive coating can comprise heat-fusible materials, such as polymeric particles, having a melting point of less than about 120° C. The thermally sensitive coating can further comprise a binder comprising a cross-linked adhesive and an adhesion promoter. The porous polymeric film can comprise polypropylene or polyethylene and the polymeric particles can comprise polyethylene having a melting point of about 113° C. In some embodiments of th e present invention, the porous polymeric film comprises polypropylene or polyethylene and the polymeric particles comprise polyethylene, such as polyethylene wax, having a melting point of about 105° C. Thus, the separator can comprise a porous material having a melting point of at least about 130° C. and a thermally sensitive coating comprising a heat-fusible material having a melting point less than the melting point of the porous material. The adhesion promoter can comprise a modified polyolefin having pendant hydroxyl functional group, pendant carboxylic functional groups, pendant chlorinated functional groups, or combinations thereof.

In other embodiments of the present invention, the thermally sensitive coating can comprise, on a dry basis, about 2% by weight (wt %) to about 10 wt % of the cross-linked adhesive. In some embodiments of the present invention, the thermally sensitive coating can comprise about 0.2 wt % to about 1 wt % or even up to 2 wt % of the adhesion promoter. In still other embodiments in accordance with the present invention, the thermally sensitive coating has a thickness of at least about 1 mil. In still further embodiments, the separator consists essentially of a porous substrate having a thermally sensitive coating consisting essentially of heat-fusible material and an adhesive and an adhesion promoter securing the heat-fusible material together and to the porous substrate.

The porous material, layer, or film can comprise a material that permits ion transport therethrough. Typically, the separator comprises a microporous film that comprises a polyhalohydrocarbon, a polyolefin, and a copolymer of ethylene and vinyl acetate or combinations, alloys, or mixtures thereof. Examples of suitable polyhalohydrocarbons include, but are not limited to polytetrafluoroethylene, copolymers of ethylene and tetrafluoroethylene, and copolymers of ethylene and chlorotrifluoroethylene. In accordance with one or more embodiments of the present invention, the porous material comprises a polyolefin having a melting point of at least about 160° C. In other embodiments however, the porous material can comprises lower melting point temperature materials such high density polyethylene having a melting point of about 130° C. In still other embodiments, the porous material comprises polybutene having a melting point of about 120° C. In yet other embodiments, the porous material has a melting point of about 80° C. For example, the porous material can comprise high-density polyethylene, polybutene, ethylene vinyl acetate or mixtures or blends thereof.

In some embodiments in accordance with the present invention, the wax or heat-fusible material, or particles, comprises polyethylene. In some cases, the wax comprises about 15% wt % to about 20 wt % of the thermally sensitive coating solution. In still other embodiments in accordance with the present invention, the adhesive comprises about 1 wt % to about 3 wt % of the thermally sensitive coating solution.

In further embodiments in accordance with the present invention, the adhesion promoter comprises about 0.5 wt % to about 2 wt % of the thermally sensitive coating solution. In some cases, the solvent comprises at least about 75 wt % of the thermally sensitive coating solution. The adhesion promoter can comprise at least one pendant moiety selected from the group consisting of hydroxyl functional groups, carboxylic functional groups, and chlorinated functional groups.

The solvent can comprise a polar component and/or a non-polar component. The solvent can further comprise a high-boiling point component. The polar component typically promotes dissolution of the adhesive material and, preferably, inhibits dissolution of the heat-fusible material. The solvent or solvent mixture should be capable of dissolving the adhesive and the adhesion promoter and suspending the heat-fusible material. Typically, the solvent has a similar specific gravity as the heat-fusible material or particles. The solvent should also be volatile so that it can easily be removed from the solution-coated porous material. Non-limiting examples of suitable solvents include ketones, such as acetone and methyl ethyl ketone; esters, such as methyl acetate, ethyl acetate, and butyl acetate; ethers, such as dimethyl ether, diethyl ether, and dibutyl ether; aromatics, such as benzene and toluene; and halogenated solvents such as carbon tetrachloride, chloroform, and methylene chloride.

In still other embodiments in accordance with the present invention, the solvent can comprise a polar component as well as a non-polar aromatic component and, in some cases, a high boiling temperature component. The solvent can also comprise at least one of toluene, ethyl acetate, isopropanol, and a higher temperature boiling solvent such as diethyleneglycol dibutylether. The high boiling temperature component typically acts as a temporary plasticizer and remains in the coating for an extended period of time during the coating drying step. This allows the adhesive and/or adhesion promoter time to remain molecularly mobile and subsequently permit increased wetting and overall adhesion to the substrate. A high boiling temperature component refers to a solvent or a mixture of solvents having a boiling point, at one atmosphere, greater than or equal to about 120° C. Preferably the high boiling temperature component has a boiling point temperature of at least about 180° C. and more preferably at least above 200° C. The present invention can utilize greater relative amounts of high boiling temperature component but too much high boiling temperature component in the coating solution may increase the drying time of the coating solution. Likewise, lesser relative amounts of high boiling temperature component can be utilized but may decrease wetting effect provided by the high boiling temperature component and, in some cases, decrease the effectiveness of the adhesive and adhesion promoter. Other mixtures such as a combination of high boiling aromatic, ketone, and ester compounds such as BYKETOL®-OK leveling paint additive from BYK-Chemie USA Inc., Wallingford, Conn., can be utilized as the high boiling temperature component in the solvent in accordance with the present invention.

Further, the solvent can comprise, inclusively or exclusively, an aromatic solvent, such as toluene or ethylbenzene. Preferably, the solvent mixture includes a polar component to reduce the likelihood of dissolving the dispersed heat-fusible material from the preferred particulate form. Thus, in some cases, the solvent can comprise a polar component, such as ethyl acetate, that can effectively adjust the effective polarity of the solution and improve long-term, e.g. at least one week, storage of the coating solution. Other suitable examples of solvents that can promote dissolution of the adhesive include, but are not limited to aromatic species such as xylene, ethylbenzene, and benzene; ketones; esters; and chlorinated solvents; or mixtures thereof. Suitable examples of solvents that can be utilized to promote dissolution of the adhesion promoter include, but are not limited to the above-mentioned aromatic species. Suitable examples of solvents that can influence the effective polarity of the solvent include, but are not limited to acetates such as ethyl acetate, ketones like acetone and methyl ethyl ketone. Preferably, the selected polar component changes the effective polarity of the solvent mixture without significantly dissolving the heat-fusible material.

In accordance with one or more embodiments, the porous material comprises voids or pores that define a porosity that allow ionic species, such as lithium ions, to diffuse, permeate, or transpire therethrough. The void volume or porosity of the porous material should be sufficient to permit favorable ion species transport. For example, the porosity of the porous material can be at least about 30%. The thickness of the porous material layer is typically less than about 3 mils. Preferably, the thickness of the separator is minimized to optimize or at least reduce volume that could otherwise be filled with active material. It is believed that the lower separator thickness limit is about 0.2 mils to provide mechanical strength because a thinner separator can become susceptible punctures, typically caused by sharp edges on the electrodes, which could result in a short circuit. The porous material typically has pore sizes that are less than about 100 microns (μm). Preferably, the pore size is less than about 10 μm and more preferably, the pore size is less than about 1 μm.

Non-limiting examples of commercially available microporous films suitable for use in the present invention include, for example, 1 mil thick CELGARD®) 2325 polyethylene film with about 41% void volume, 1 mil thick CELGARD® 2400 polypropylene film with about 35% void volume, 1 mil thick CELGARD® 2500 polypropylene film with about 45% void volume, each available from Celanese Corporation. Other commercially available porous materials that can be utilized in accordance with the present invention include HIPORE™ polyolefin flat film membrane available from Asahi Kasei Corporation, Tokyo, Japan including, for example, 1 mil thick HIPORE™ 720 microporous high density polyethylene with about a 37% void volume, 0.64 mil thick HIPORE™ 8416 microporous high density polyethylene with about a 41% void volume, 1 mil thick HIPORE™ 9420 microporous high density polyethylene with about a 41% void volume, and 1 mil thick HIPORE™ 6022 microporous high density polyethylene with about a 50% void volume.

The thermally sensitive layer or coating or heat-fusible coating typically comprises a polymeric material and a binder typically securing heat-fusible particles or layers of polymeric material to each other and, in some cases, to the porous material. The thermally sensitive layer has a thickness that provides sufficient amount of heat-fusible material to effectively render the porous material substantially ionically impermeable to prevent or inhibit any further electrochemical reactions, at least within a localized region. For example, the thermally sensitive layer can be at least about 1 mil thick.

The heat-fusible, polymeric material can comprise a material having a melting point below the melting point of the porous material. In accordance with one or more embodiments of the present invention, the melting point of the heat-fusible polymeric material is greater than a typical exposure or operating temperature within an electrochemical cell during normal operation or in storage and, in some cases, less than the melting temperature of the porous material. Such a difference in melting temperature range can ensure that an electrochemical cell in accordance with the present invention would shut down, or at least become locally ionically impermeable in a safe operating temperature while providing sufficient operating flexibility. For example, the heat-fusible material can have a melting temperature of at least about 60° C. and/or less than about 120° C. Preferably, the heat-fusible material has a melting temperature of at least about 80° C. More preferably, the heat-fusible material has a melting temperature between about 90° C. and about 110° C. In other embodiments in accordance with the present invention, the heat-fusible material has a melting temperature of about, 120° C., and preferably, about 113° C., and more preferably, about 105° C. In other embodiments, the heat-fusible material has a melting point temperature at least about 30° C. less than a melting point temperature of the porous material and in other cases, the difference between melting point temperatures is less than about 20° C., and in still other cases, less than about 10° C.

The melt viscosity of the heat-fusible polymeric material can affect the flow rate of the molten heat-fusible polymeric material, which in turn can affect the time before which the porous polymeric film has been rendered at least partially ionically impermeable. The melt viscosity is preferably sufficiently low that the melted heat-fusible polymer tends to flow into the pores of the microporous layer. In accordance with one or more embodiments of the present invention, the melt viscosity of the material is less than about 500 cps, and in other cases, less than 50 cps, and in still other cases, less than 10 cps. However, materials with a melt viscosity greater than about 500 cps may be suitable because, it is believed, they can melt and form an ion impermeable layer on a surface of the porous material, even without significant pore penetration.

Suitable heat-fusible materials having the acceptable melting point and melt viscosity include, but are not limited to, petroleum waxes, such as paraffin wax and microcrystalline wax; natural waxes such as carnauba, jojoba, candelilla, Japan wax, ouricuri, beeswax, shellac wax, spermaceti wax, rice bran wax, and castor wax; mineral waxes such as montan, ozocerite, ceresin, and peat; synthetic waxes such as polyethylene, Fisher-Tropsch waxes, oxidized polyethylene; fatty acids; fatty alcohols; fatty amides; fatty esters; and ethylene copolymers such as ethylene-vinyl acetate, ethylene-acrylate, and ethylene-acrylic acid as well as blends or mixtures thereof.

Examples of commercially available heat-fusible materials include the family of POLYWAX® polyethylene wax available from Baker Petrolite Corporation, Sugarland, Tex., such as POLYWAX® 500 polyethylene wax, POLYWAX® 655 polyethylene wax, POLYWAX® 1000 polyethylene wax, and POLYWAX® 2000 polyethylene wax. MPP-550 micronized polyethylene wax, available from Micro Powders, Inc., Tarrytown, N.Y., can also be utilized as the heat-fusible polymeric material in accordance with one or more embodiments of the present invention.

In accordance with one or more embodiments of the present invention, the adhesive can be capable of binding the particles of heat-fusible polymeric material together and binding such particles to the porous material. The adhesive should be used in an amount sufficient to bind the particles together without being excessive to encapsulate the particles or to block the pores of the microporous layer. The dry weight of adhesive should be at least 2% of the weight of particles to provide sufficient binding and not more than 10% of the weight of the particles to prevent encapsulation.

In some cases, the adhesive and/or the adhesion promoter should be insoluble in electrolyte materials to avoid any disintegration in the electrolyte. The adhesive and/or the adhesion promoter should be soluble in a solvent used to prepare a coating solution having a suspension of heat-fusible particles. Insolubility can be achieved by, for example, selecting an adhesive that can be cross-linked or an adhesive and/or an adhesion promoter with a solubility parameter below about 8 hildebrands as described by Treger in U.S. Pat. No. 5,091,272, which is incorporated herein by reference in its entirety. Non-limiting examples of cross-linkable adhesives include acrylic copolymers, carboxylic copolymers, urethane copolymers, ethylene vinyl acetate carboxylic acid terpolymers, silicone rubbers, nitrile rubbers, and neoprene. Non-limiting examples of adhesives with low hildebrand solubility parameters include natural rubber, butyl rubber, polyisobutylene, styrene-butadiene, silicone, styrene-isoprene, and polysulfide.

A preferred class of adhesives is acrylic copolymers with a high degree of tack. Preferably, the acrylic polymer has a glass transition temperature less than the melting point of the particles, more preferably less than room temperature, and most preferably less than about 0° C. An example of a suitable commercially available adhesive material is GELVA® 2480 acrylic adhesive, available from Solutia, Inc., St. Louis, Mo. or UCB Surface Specialties, Itasca, Ill.

In accordance with one or more embodiments, the present invention provides a method of preparing a thermally sensitive coating solution that can be utilized to coat at least one surface of the porous material of the separator. In accordance with one or more embodiments, the thermally sensitive coating solution can be prepared by creating a suspension comprising heat-fusible polymeric material particles, an adhesion promoter and an adhesive in a solvent mixture having polar, non-polar and high boiling temperature components. For example, the thermally sensitive separator coating solution in accordance with one or more embodiments of the present invention can comprise about 15 wt % to about 20 wt % heat-fusible polymeric materials, about 0.8 wt % to about 3 wt % cross-linkable adhesive, about 0.2 wt % to about 1.7 wt % adhesion promoter, about 40 wt % to about 66 wt % non-polar aromatic solvent such as toluene, about 15 wt % to about 20 wt % of a first polar solvent such as ethyl acetate, about 2 wt % to about 10 wt % of a second polar solvent such as isopropanol, and about 2 wt % to about 10 wt % of a high boiling temperature solvent such as diethyleneglycol dibutylether or a mixture of high boiling aromatics, ketones, and esters such as BYKETOL®-OK paint additive.

The thermally sensitive coating solution of the present invention can be prepared by adding or dissolving the cross-linkable adhesive and the adhesion promoter in the polar solvent component. This step can be performed at room temperature or any temperature that promotes such dissolution. The polar solvent components can be subsequently added and followed by the heat-fusible material. The mixture is typically mixed until dispersed, preferably until a smooth, agglomeration-free coating layer can be applied. Various techniques and devices can be utilized to ensure an agglomeration-free coating mixture including, for example, utilizing steel beads or balls during mixing or shaking alone or in combination with filtration. Other methods such as mixing in a tank with a stirrer or impeller can also be utilized.

In accordance with one or more embodiments, the present invention provides a method of preparing a separator with a thermally sensitive coating comprising disposing a porous material into a thermally sensitive coating solution, removing the microporous film from the thermally sensitive coating solution, and evaporating any solvent from the thermally sensitive coating solution. This can be referred to as dip coating. Alternative techniques that can be used in accordance with the present invention to apply the coating solution include, for example, spray coating, gravure coating, slotted die coating, reverse roll, metering rod and knife over roll coating. In some cases, the thermally sensitive coating solution is removed from one side of the porous material so that the resultant separator has heat-fusible particles coated only on one side. In accordance with one or more embodiments of the present invention, the thermally sensitive separator can comprise, or in some cases consist essentially of, a porous material or film having, on a dry basis, about 89 wt % to about 98.2 wt % heat-fusible material, about 2 wt % to about 10 wt % cross-linked adhesive, and about 0.1 wt % to about 2 wt % adhesion promoter.

If the adhesive is cross-linkable, the method can further comprise promoting or effecting cross-linking the adhesive by, for example, applying heat to the separator. The time and temperature necessary to effect cross-linking typically depends on several factors including, but not limited to, the cross-linking adhesive as well as the desired cross-link density.

The adhesion promoter can be any material that facilitates wetting and bonding of the porous material with the thermally-sensitive material. Preferably, the adhesion promoter, like the adhesive and the heat-fusible polymeric material as well as the porous material, is chemically inert at the operating temperatures of the electrochemical device. The adhesion promoter typically comprises a polar modified polyolefin, such a modified polyolefin comprising pendant functional groups that promote creation of bonds to the adhesive material and/or the heat-fusible polymeric material. Examples of suitable functional groups include, but are not limited to, hydroxyl and carboxylic moieties. In some embodiments, the polyolefin comprising the adhesion promoter comprises chlorinated pendant functional groups. Examples of suitable adhesion promoters include UNISTOLE® P modified polyolefin, available from Mitsui Chemical America, Inc., Purchase, N.Y., and EASTMAN™ AP550 polyolefin adhesion promoter, available from Eastman Chemical Company, Kingsport, Tenn.

In accordance with other embodiments, the present invention can utilize a material to improve wetting of the porous material and/or the heat-fusible material with the adhesive. In accordance with one or more embodiments of the present invention, a tackifying material, typically a tackifying resin, may be utilized to promote wetting of the porous material. The tackifying resin can be utilized with or, in some cases, as the adhesion promoter. For example, in accordance with one or more embodiments, the present invention can provide a thermally sensitive coating solution comprising an adhesive, a tackifying resin, and heat-fusible material or particles. In accordance with other embodiments of the present invention, the thermally sensitive coating solution can comprise an adhesive, an adhesion promoter, a tackifying resin, and heat-fusible materials or particles. The coating solution can further comprise solvent or a solvent mixture. In accordance with further embodiments of the present invention, the coating solution can consist essentially of heat-fusible material, an adhesive, a tackifying resin, and a solvent or solvent mixture. In accordance with still further embodiments, the coating solution can consist of heat-fusible material, an adhesive, a tackifying resin, and a solvent or solvent mixture. The adhesion promoter comprising a tackifying resin can comprise about 0.2 wt % to about 2 wt % of the thermally sensitive coating.

Tackifying resins can have lower molecular weights compared to modified polyolefin adhesion promoters and can be more soluble in electrolytes typically utilized in Li-ion electrochemical cells. Tackifying resins can modify the viscoelastic properties of an adhesive by, in some cases, improving wetting and adhesion to a substrate. In some cases, however, the use of tackifying resins may be undesirable especially where the tackifying resin dissolves in or otherwise interacts or interferes with a component of an electrochemical cell, such as an electrolyte material. In such instances, the use of an adhesion promoter, such as a modified polyolefin, that is chemically and/or electrically inert in an electrochemical cell may be preferred.

Tackifying resins or tackifiers that can be utilized in accordance with one or more embodiments of the present invention include one or more rosin type resins such as those in the SYLVALITE™ resin family including SYLVALITE™ RE 80 HP ester of rosin available from Arizona Chemical Company, Jacksonville, Fla.; hydrocarbon resins such as those in the REGALREZ® resin family including REGALREZ® 1018 hydrogenated pure monomer resin available from Eastman Chemical Company, Kingsport, Tenn. or the ESCOREZ™ resin family such as ESCOREZ™ 1580 petroleum hydrocarbon resin available from ExxonMobil Chemical, Houston, Tex.; coumarone-indene resins such as those in the CUMAR® resin family including CUMAR® R9 resin available from Neville Chemical Company, Pittsburgh, Pa.; terpene resins such as those in the SYLVAGUM™ and SYLVARES™ resin families available from Arizona Chemical Company, Jacksonville, Fla.; and terpene-phenolic resins such as SYLVAREZ™ TP96 rosin available from Arizona Chemical Company, Jacksonville, Fla. The choice of tackifying resin can be dictated by the solubility parameter of the adhesive. For example, suitable tackifying resins for an adhesive comprising an acrylic polymer include, but are not limited to, rosin esters, terpene phenolics and coumarone-indene.

In some cases, tackifying resins can improve adhesion of the heat-fusible material to the porous material or substrate but adhesion promoters comprising polar modified polyolefins may be preferable because the latter can further enhance adhesion to the porous substrate. Further, adhesion promoters comprising polar modified polyolefins can be more stable, i.e. not interact or become soluble, in electrolyte materials typically utilized in Li-ion electrochemical devices. That is, in some instances, the solubility of tackifying resins in Li-ion electrolyte may not be desirable because it can promote undesirable or detrimental electrochemical reactions, such as corrosion or redox reactions.

The pore size and/or porosity of the substrate, and to a lesser extent, the particle size of thermally sensitive material, can affect on the rate of thermal shutdown of electrochemical devices utilized in accordance with articles and techniques of the present invention. The systems and techniques of the present invention can increase the rate of thermal shutdown of electrochemical devices by utilizing porous materials or substrates having smaller pore sizes and/or lower porosity and/or smaller heat-fusible material particle sizes. This is unexpected because decreasing pore sizes, especially in the micro or submicron regime can be more difficult to fill with a fluid or molten material because, it is believed, wetting of such structures can become more difficult when surface tension forces become predominant. A faster thermal shutdown can be desirable in certain applications to rapidly shutdown an electrochemical cell that may be undergoing undesirable high current conditions in order to more reliably prevent fire or explosion, and especially in applications involving large hybrid electric vehicles which typically have larger and more numerous cells than consumer-oriented electronic devices.

The function and advantage of these and other embodiments of the present invention will be more fully understood from the examples below. The following examples are intended to illustrate the benefits of the present invention, but do not exemplify the full scope of the invention.

### EXAMPLE 1

### Separator Coating Solution and Electrochemical Cell Shutdown Evaluation

A separator coating solution was prepared to have the composition listed in Table 1. The adhesive and adhesion promoter were added to the solvents and mixed at room temperature with a shaker mixer for about 15 minutes. The heat-fusible material was then added and mixed in the solvent solution in the shaker mixer with steel balls until the solution was free of any agglomeration. The coating solution was utilized to coat various porous materials having various porosities and pore sizes as listed in Table 2 by dip-coating the each of the various porous materials in the solution at room temperature and withdrawing therefrom at about 20 ft/min.

The coated separator was dried at about 60° C. in hot air. To promote cross-linking of the adhesive, the dried, coated separator was baked for about 24 hours at about 60° C.

Various cells were assembled comprising the various cured, coated separators by placing a section, approximately 1.5 cm², in a sealed conductivity cell filled with about 3.5 ml of 1 M LiTFS propylene carbonate/methoxyethylether (1:1 ratio by volume). The conductivity cell was constructed of gold plated steel with 1.5 cm² circular gold plated polished steel electrodes and TEFLON™ coated insulators. The cell was hermetically sealed following assembly.

Each of the various cell assemblies were evaluated by measuring the AC impedance while being heated in an oven at about 170° C. Impedance was measured using an SI 1260 impedance analyzer, available from Schlumberger, Inc., coupled with a Model 273A potentiostat, from EGG, controlled by ZPLOT impedance software generating a 60 KHz, 1 mV signal. The conductivity was measured for each assembly and the shutdown time was determined when the loss of conductivity was at 90% of the conductivity as measured at 30° C.

The data in Table 2 shows that the separator coating solution can be prepared and utilized with several porous materials to fabricate a thermally sensitive separator in accordance with one or more embodiments of the present invention. The data also shows that the porosity of the separator can influence shutdown time. In particular, the data shows that decreasing porosity, as well as decreasing pore size, can reduce the shutdown time.

TABLE 1
Coating solution composition.

| Ingredient | Weight Percent |
|---|---|
| Heat-fusible material | 17.2 |
| (POLYWAX ® 1000) | |
| Adhesive | 1.8 |
| (GELVA ® 2480) | |
| Adhesion promoter | 0.9 |
| (UNISTOLE ® P401) | |
| Toluene | 55.3 |
| Ethyl acetate | 17.2 |
| Isopropanol | 3.8 |
| Diethyleneglycol dibutylether | 3.8 |

TABLE 2
Porous material separator performance coated with
the thermally sensitive coating formulation listed
in Table 1 to a dry thickness of about 1 mil.

| | | | Shutdown |
|---|---|---|---|
| | Porosity | Pore Size | Time |
| Porous Material Separator | (%) | (μm) | (sec) |
| CELGARD ® 2500 | 55 | 0.2 | >360 |
| HIPORE ™ 6022 | 50 | 0.5 | 220 |
| HIPORE ™ 9420 | 41 | 0.2 | 80 |
| HIPORE ™ 8416 | 41 | 0.1 | 90 |
| HIPORE ™ 720 | 37 | 0.1 | 70 |

### EXAMPLE 2

### Effect of Heat-Fusible Particle Size on Shutdown Rate

This example evaluates effect of particle size of the heat-fusible material on shutdown rate. A coating solution was prepared as in Example 1. A second coating solution was also prepared as in Example 1 except that POLYWAX® 850 polyethlene was used in place of POLYWAX® 1000 polyethylene for the heat fusible heat-fusible material. POLYWAX® 850 polyethylene has a larger average particle size than POLYWAX® 1000 polyethylene, as shown in Table 3. Two separators were prepared by coating a HIPORE™ 720 microporous polyethylene film with each of the prepared coating solutions. The coated separators were then evaluated for shutdown time as described in Example 1.

The data in Table 3 show that heat-fusible materials having smaller particle size can lead to faster shutdown rates compared to heat-fusible materials having larger particle size.

TABLE 3
Effect of heat-fusible particle size on thermal shutdown rate using
coated HIPORE ™ 720 microporous polyethylene membrane.

| | Particle size, | Shutdown Time |
|---|---|---|
| Wax particle | Avg. (μm) | (sec) |
| POLYWAX ® 1000 | 6 | 80 |
| POLYWAX ® 850 | 10 | 120 |

### EXAMPLE 3

### Separator Coating Solutions

Various separator coating solutions comprising the composition listed in Table 1 were prepared as in Example 1 utilizing various high-boiling temperature solvents, listed in Table 4, in place of diethyleneglycol dibutylether. The extent to which the adhesive was dissolved was evaluated and also listed.

TABLE 4
Solubility of other high boiling temperature solvents.

| | Solubility of GELVA ® |
|---|---|
| Solvent | 2480/UNISTOLE ® P401 |
| Diethyleneglycol dibutylether | Acceptable |
| BYKETOL ® -OK | Acceptable |
| Diethylene glycol mono-n-butyl | Not Acceptable |
| ether acetate | |
| Trimethylene pentanediol | Not acceptable |
| monoisobutyrate | |
| Diethlyene glycol diethyl ether | Not acceptable |
| Ethylene glycol n-butyl ether | Not acceptable |
| Diethylene glycol n-butyl ether | Not acceptable |
| Ethylene glycol phenyl ether | Not acceptable |
| Propylene glycol n-butyl ether | Not acceptable |
| Dipropylene glycol n-butyl ether | Not acceptable |
| Propylene glycol phenyl ether | Not acceptable |

The data listed in Table 4 show that only certain solvents can be utilized to render the adhesive and adhesion promoter sufficiently soluble while providing sufficient wetting of the porous substrate during drying.

The use of high boiling solvents in the solvent bath composition improved the adhesion of the thermally sensitive coating in addition to the use of the adhesion promoter.

### EXAMPLE 4

### Evaluation of Electrochemical Devices Utilizing Various Thermally Sensitive Coated Separators

Various porous materials were coated with the coating solution as described in Example 1. The coated separator materials were then used to assemble electrochemical devices and the performance of each were evaluated.

The various electrochemical devices comprised of a 20 mm diameter CR2016 Li-ion coin cells containing a mesoporous carbon microbeads carbon anode, a nickel substituted Lithium cobaltite cathode and 1 M LiPF₆ ethylene carbonate:dimethyl carbonate 1:1 (v/v) (EC:DEC 1:1) electrolyte. For thermal shutdown testing, the coin cells were charged at about a C/5 rate to about 4.2V then heated in an oven at about 170° C. The coin cells were discharged at about a C/10 rate. The exposure temperature and cell voltages were monitored until shutdown.

It can be seen from the data in Table 5 that the electrochemical cells utilizing a coated separator have comparable initial capacity and comparable 50-cycle capacity to electrochemical cells utilizing an uncoated separator. The data in Table 5 also show that the high rate capability of the electrochemical cells utilizing coated separators typically were somewhat less than the high rate capability of electrochemical cells utilizing uncoated separators as noted by the lower 5C capacity as a percent of the C/5 capacity. Nonetheless, the data show that coated separators prepared in accordance with the articles and techniques of the present invention can provide acceptable or electrochemically compatible thermally sensitive separators utilizable in typical electrochemical cells.

TABLE 5
Measured thermal shutdown and electrochemical performance data.

| | | | | Shutdown | | | |
|---|---|---|---|---|---|---|---|
| | | | | Time and | | | |
| | | | | Temperature | | 5C | |
| Separator | Thickness | Porosity | Pore Size | (sec) | C/5 Capacity | capability | 50 Cycle life |
| Substrate | (μm) | (%) | (μm) | (° C.) | (mAh/g) | (% vs C/5) | (% cap) |
| Coated | 50 | 55 | 0.2 | >360 | | | |
| CELGARD ® 2500 | | | | 110 | | | |
| Uncoated | 25 | 55 | 0.2 | | 135 | 57 | |
| CELGARD ® 2500 | | | | | | | |
| Coated | 50 | 41 | 0.1 | 190 | 136 | 26 | 78.7 |
| CELGARD ® 2325 | | | | 110 | | | |
| Uncoated | 25 | 41 | 0.1 | 20 | 137 | 31 | 76.3 |
| CELGARD ® 2325 | | | | 136.5 | | | |
| Coated HIPORE ™ | 50 | 50 | 0.5 | 220 | | | |
| 6022 | | | | 110 | | | |
| Uncoated | 25 | 50 | 0.5 | | 135 | 62 | 65.5 |
| HIPORE ™ 6022 | | | | | | | |
| Coated HIPORE ™ | 50 | 41 | 0.2 | 80 | | | |
| 9420 | | | | 110 | | | |
| Uncoated | 25 | 41 | 0.2 | | 132 | 38 | 71 |
| HIPORE ™ 9420 | | | | | | | |
| Coated HIPORE ™ | 40 | 41 | 0.1 | 90 | | | |
| 8416 | | | | 110 | | | |
| Uncoated | 16 | 41 | 0.1 | | 132 | 20 | |
| HIPORE ™ 8416 | | | | | | | |
| Coated HIPORE ™ | 50 | 37 | 0.1 | 70 | 137 | 22 | 76 |
| 720 | | | | 110 | | | |
| Uncoated | 25 | 37 | 0.1 | 20 | 136 | 34 | 78.5 |
| HIPORE ™ 720 | | | | 134.5 | | | |

### EXAMPLE 5

### Effects of Adhesion Promoter on Coating Adhesion

Several coated separators were prepared by coating a HIPORE™ 720 microporous polyethylene film with a coating solution formulation as listed in Table 7 and as described in Example 1 except that various adhesion promoters were utilized. Table 6 lists adhesion test data pertaining to the adhesion quality utilizing the adhesion promoters of the present invention.

A scrape adhesion test was utilized to evaluate the adhesion of the thermally sensitive coating on the separator film. The scrape adhesion test utilized was modified from the procedure described in ASTM D-2197. The scrape adhesion test comprised placing a polished hemispherical terminated probe with a contact area of about 0.5 mm² and a contact pressure of about 100 gM/mm² onto the surface of the coated separator and pulling the coated separator at a right angle relative to the probe at a rate of about 1.0 in/sec. The applied coating passed the test if it was not scraped from the underlying substrate. The applied coating failed the test if it scraped off the surface of the substrate.

A 180-degree bend test was also utilized. The bend test comprised bending the coated separator by about 180-degree to form a crease. The applied coating passed the test if it did not crack and did not fall off the substrate. The applied coating failed the test if it cracked and fell of the substrate.

TABLE 6
Coating adhesion performance.

| | | % dry | | |
|---|---|---|---|---|
| | | adhesion | | |
| | | promoter | | 180- |
| | | in dry | | degree |
| | Adhesion | coating | Scrape | Bend |
| Adhesion Promoter | Promoter Type | (w/w) | Test | Test |
| None | — | none | fail | fail |
| UNISTOLE ® P401 | Polar modified | 0.5 | pass | pass |
| | polyolefin | | | |
| UNISTOLE ® P801 | Polar modified | 0.5 | pass | pass |
| | polyolefin | | | |
| EASTMAN ™ AP550 | Polar modified | 0.5 | pass | pass |
| | polyolefin | | | |
| SYLVAREZ ™ TP96 | Terpene | 1.0 | fail | fail |
| | phenolic resin | | | |
| CUMAR ™ R29 | Coumarone- | 1.0 | fail | fail |
| | indene resin | | | |
| SYLVALITE ™ RE | Rosin ester | 1.0 | fail | pass |
| 80 HP | resin | | | |

TABLE 7
Coating solution formulation.

| Ingredient | Weight Percent |
|---|---|
| Heat-fusible material | 17.2 |
| (POLYWAX ® 10000) | |
| Adhesive | 1.8 |
| (GELVA ® 2480) | |
| Toluene | 56.2 |
| Ethyl acetate | 17.2 |
| Isopropanol | 3.8 |
| Diethyleneglycol dibutylether | 3.8 |

The data in Table 6 show that incorporating an adhesion promoter in a thermally sensitive coating can improve the adhesion of a thermally sensitive coating to porous materials suitable as separators. The data further shows that an adhesion promoter comprising a polar modified polyolefin can provide superior adhesion enhancement compared to adhesion promoters comprising tackifier resins.

### EXAMPLE 6

### Solubility of various adhesion promoters in 1M LiPF₆ EC:DEC 1:1 electrolyte at about 60° C. for about 24 hours.

This example evaluates the stability/compatibility of various adhesion promoters in typical Li-ion electrochemical cells. In particular, the solubility of various adhesion promoters in a typical Li-ion electrolyte was evaluated. The solubility was judged by contacting, i.e. adding, about 0.02 gram of adhesion promoter to about 2 grams of electrolyte. After about 24 hours at a temperature of about 60° C., if the adhesion promoter was dissolved in the electrolyte, then it was judged to be soluble, hence unsuitable for use in an electrochemical device comprising a LiPF₆ electrolyte. If the electrolyte became turbid after cool-down to room temperature but the adhesion promoter was not fully dissolved, then it was judged to be partially soluble. If the adhesion promoter was not dissolved and the electrolyte remained clear, then it was judged to be insoluble, hence suitable for use in an electrochemical device comprising a LiPF₆ electrolyte.

TABLE 8
Solubility of various adhesion promoters.

| | Adhesion | |
|---|---|---|
| Adhesion Promoter | Promoter Type | Electrolyte Solubility |
| UNISTOLE ® P401 | Polar modified | Insoluble |
| | polyolefin | |
| UNISTOLE ® P801 | Polar modified | Insoluble |
| | polyolefin | |
| EASTMAN ™ AP550 | Polar modified | Insoluble |
| | polyolefin | |
| SYLVALITE ™ RE 80 HP | Rosin ester | Partially soluble |
| | tackifier resin | |
| SYLVAREZ ™ TP96 | Terpene | Partially soluble |
| | phenolic | |
| | tackifier resin | |
| Adhesion Promoter | Adhesion | Electrolyte Solubility |
| | Promoter Type | |
| CUMAR ™ R29 | Coumarone- | Partially soluble |
| | indene tackifier | |
| | resin | |

The data in Table 8 indicate that polar modified polyolefins are less soluble in an electrolyte comprising about 1M LiPF₆ EC:DEC 1:1 than some tackifier resins.

While several embodiments of the invention have been described and illustrated herein, those of ordinary skill in the art will readily envision a variety of other means and structures for performing the functions and/or obtaining the results or advantages described herein, and each of such variations or modifications is deemed to be within the scope of the present invention. More generally, those skilled in the art would readily appreciate that all parameters, dimensions, materials, and configurations described herein are meant to be exemplary and that actual parameters, dimensions, materials, and configurations will depend upon specific applications for which the teachings of the present invention are used. Those skilled in the art will recognize, or be able to ascertain using no more than routine experimentation, many equivalents to the specific embodiments of the invention described herein. Moreover, those skilled in the art would recognize that ancillary systems and/or devices can be utilized in the present invention. It is, therefore, to be understood that the foregoing embodiments are presented by way of example only and that, within the scope of the appended claims and equivalents thereto, the invention may be practiced otherwise than as specifically described. For example, the separator coating solution of the present invention can include, exclusively, a heat-fusible material, an adhesive, an adhesion promoter, each dispersed in a solvent consisting essentially of a polar component, a non-polar component, and a high boiling point component. The coating solution can also consist essentially of a heat-fusible material, an adhesive, an adhesion promoter, each dispersed in a solvent or solvent mixture consisting essentially of a polar component, a non-polar component, and a high boiling point component. The present invention is directed to each individual feature, system, material and/or method described herein. In addition, any combination of two or more such features, systems, materials and/or methods, if such features, systems, materials and/or methods are not mutually inconsistent, is included within the scope of the present invention.

In the claims as well as in the description above, all transitional phrases such as “comprising,” “including,” “carrying,” “having,” “containing,” “involving,” and the like are to be understood to be open-ended, i.e. to mean including but not limited to. Only the transitional phrases “consisting of” and “consisting essentially of” shall be closed or semi-closed transitional phrases, respectively.

1. A thermally sensitive coating solution for a battery separator, comprising:
a plurality of heat-fusible particles;
an adhesive comprising a cross-linkable polymer;
an adhesion promoter comprising a polar modified polyolefin; and
a solvent.

2. The thermally sensitive coating solution of claim 1 wherein the heat-fusible particles comprises polyethylene having a melting point of about 85° C. to about 120° C.

3. The thermally sensitive coating solution of claim 2 wherein the heat-fusible particles comprises about 15 wt % to about 20 wt % of the thermally sensitive coating solution.

4. The thermally sensitive coating solution of claim 3 wherein the adhesive comprises about 1 wt % to about 3 wt % of the thermally sensitive coating solution.

5. The thermally sensitive coating solution of claim 4 wherein the adhesion promoter comprises about 0.5 wt % to about 2 wt % of the thermally sensitive coating solution.

6. The thermally sensitive coating solution of claim 5 wherein the solvent comprises at least about 75 wt % of the thermally sensitive coating solution.

7. The thermally sensitive coating solution of claim 1 wherein the solvent comprises a high boiling temperature solvent.

8. The thermally sensitive coating solution of claim 7 wherein the high boiling point solvent comprises at least one solvent selected from the group consisting of diethyleneglycol dibutylether and a mixture of high boiling aromatics, ketones, and esters.

9. The thermally sensitive coating solution of claim 1 wherein the adhesion promoter comprises at least one pendant moiety selected from the group consisting of hydroxyl functional groups, carboxylic functional groups, and chlorinated functional groups.

10. The thermally sensitive coating solution of claim 9 wherein the solvent comprises a polar component and a non-polar component.

11. The thermally sensitive coating solution of claim 10 wherein the solvent comprises at least one of toluene, ethyl acetate, isopropanol, and diethyleneglycol dibutylether.

12. A batter separator comprising a porous polymeric film with a melting point of at least about 130° C. coated with a thermally sensitive coating disposed on a surface of the porous polymeric film and a binder comprising a cross-linked adhesive and an adhesion promoter, the thermally sensitive coating comprising heat-fusible polymeric particles having a melting point of less than the melting point of the porous polymeric film.

13. The battery separator of claim 12 wherein the porous polymeric film comprises polypropylene and the heat-fusible polymeric particles comprises polyethylene having a melting point of about 113° C.

14. The battery separator of claim 12 wherein the porous polymeric film comprises polypropylene and the heat-fusible polymeric particles comprises polyethylene having a melting point of about 105° C.

15. The battery separator of claim 12 wherein the adhesion promoter comprises a modified polyolefin having pendant hydroxyl functional groups.

16. The battery separator of claim 12 wherein the adhesion promoter comprises a modified polyolefin having pendant carboxylic functional groups.

17. The battery separator of claim 12 wherein the adhesion promoter comprises a modified polyolefin having pendant chlorinated functional groups.

18. The battery separator of claim 12 wherein the adhesion promoter comprises a tackifying resin.

19. The battery separator of claim 12 wherein the thermally sensitive coating comprises about 2 wt % to about 10 wt % cross-linked adhesive.

20. The battery separator of claim 12 wherein the thermally sensitive coating comprises about 0.2 wt % to about 2 wt % adhesion promoter.

21. An electrochemical cell comprising:
a separator disposed to electrically separate an anode and a cathode,
wherein the separator comprises a porous polymeric material and a thermally sensitive coating disposed on a surface of the separator, the thermally sensitive coating comprising heat-fusible polymeric particles, an adhesion promoter comprising a polyolefin having at least one pendant hydroxyl, carboxylic and chlorinated functional group, and a cross-linked adhesive.

22. The electrochemical cell of claim 21 wherein a melting point of the heat-fusible polymeric particles is less than a melting point of the porous polymeric material.

23. The electrochemical cell of claim 22 wherein the melting point of the heat-fusible polymeric particles is less than about 120° C.

24. The electrochemical cell of claim 23 wherein the melting point of the heat-fusible polymeric particles is about 113° C.

25. The electrochemical cell of claim 23 wherein the melting point of the heat-fusible polymeric particles is about 105° C.

26. The electrochemical cell of claim 21 wherein the adhesion promoter comprises about 0.2 wt % to about 2 wt % of the thermally sensitive coating.

27. The electrochemical cell of claim 21 wherein the cross-linked adhesive comprises about 2 wt % to about 10 wt % of the thermally sensitive coating.

28. A method of preparing a separator coating solution comprising:
dissolving a cross-linkable adhesive in a solvent solution comprising a polar component, a non-polar component and a high boiling point component selected from the group consisting of diethyleneglycol dibutylether and a mixture of aromatics, ketones, and esters; and
dispersing heat-fusible material in the solvent solution.

29. The method of claim 28 further comprising dissolving an adhesion promoter comprising a modified polyolefin in the solvent solution.

30. The method of claim 29 wherein the adhesion promoter comprises a modified polyolefin.

31. The method of claim 30 wherein the modified polyolefin comprises at least one pendant moiety selected from the group consisting of hydroxyl, carboxylic, and chlorinated functional groups.

32. The method of claim 28 further comprising adding a tackifying resin to the solvent solution.

33. A method of preparing a thermally sensitive separator comprising:
providing a coating solution comprising a heat-fusible material, an adhesive and an adhesion promoter in a solvent solution comprising a polar component, a non-polar component and a high boiling point component selected from the group consisting of diethyleneglycol dibutylether and a mixture of aromatics, ketones, and esters;
applying the coating solution on a surface of a porous material; and
vaporizing at least a portion of the solvent from the coating solution to coat the surface of the porous material with a thermally sensitive layer comprising the heat-fusible material.

34. The method of claim 33 further comprising heating the coated porous material to promote cross-linking of the adhesive.

35. The method of claim 33 wherein the adhesion promoter comprises a tackifying resin.

36. A method of coating a separator comprising:
preparing a coating solution consisting essentially of a plurality of heat-fusible materials, an adhesive, an adhesion promoter and a solvent mixture;
applying the coating solution on a surface of the separator; and
vaporizing at least a portion of the solvent from the coating solution to coat the surface of the separator with a thermally sensitive layer comprising a heat-fusible material.
